(19) United States
(12) Patent Application Publication
(10) Pub. No.: US 2013/0112625 A1
(43) Pub. Date: May 9, 2013

(54) CONSOLIDATED NANOFIBER NONWOVENS AND CONSOLIDATED NANOFIBER NONWOVEN COMPOSITES CONTAINING ROPED FIBER BUNDLES

(71) Applicants: Pradipkumar Bahukudumbi, Greenville, SC (US); Kirkland W. Vogt, Simpsonville, SC (US); Dale S. Kitchen, Boiling Springs, SC (US); Randolph S. Kohlman, Boiling Springs, SC (US)

(72) Inventors: Pradipkumar Bahukudumbi, Greenville, SC (US); Kirkland W. Vogt, Simpsonville, SC (US); Dale S. Kitchen, Boiling Springs, SC (US); Randolph S. Kohlman, Boiling Springs, SC (US)

(21) Appl. No.: 13/292,705

(22) Filed: Nov. 9, 2011

(51) Int. Cl. B01D 39/16; B01D 53/02; D04H 3/005; B32B 5/26; B32B 27/02; B01D 15/00; D04H 13/00; B82Y 99/00; B82Y 30/00

(52) U.S. Cl. 210/660; 95/90; 442/344; 442/268; 442/319; 442/277; 977/700; 977/902

(57) ABSTRACT

A consolidated nanofiber nonwoven comprising a plurality of roped fiber bundles having a length axis. The roped fiber bundles comprise a plurality of nanofibers having a median diameter of less than one micrometer, where at least 50% by number of the nanofibers are oriented within 45 degrees of the length axis of the roped fiber bundles. The nanofibers within the same roped fiber bundle are entangled together. The roped fiber bundles are randomly oriented within the nanofiber nonwoven and are entangled with other roped fiber bundles within the nanofiber nonwoven. At least a portion of the nanofibers are entangled with and adhered to other nanofibers within the same roped fiber bundle and at least a portion of the roped fiber bundles are entangled with and adhered to other roped fiber bundles within the consolidated nanofiber nonwoven.

### FIELD OF THE INVENTION

The present invention generally relates to consolidated nonwovens containing roped fiber bundles containing nanofibers.

### BACKGROUND

There are a number of products in various industries, including automotive, office and home furnishings, construction, and others; that require nonwoven materials having a z-direction thickness to provide thermal, sound insulation, aesthetic, and other performance features. In home and office furnishing, and construction applications these materials are often used as structural elements to which exterior decorative materials might be added.

There is a need for a consolidated nanofiber nonwoven having reduced weight, improved performance properties, and lower materials and manufacturing costs.

### BRIEF SUMMARY

A consolidated nanofiber nonwoven comprising a plurality of roped fiber bundles having a length axis. The roped fiber bundles comprise a plurality of nanofibers having a median diameter of less than one micrometer, where at least 50% by number of the nanofibers are oriented within 45 degrees of the length axis of the roped fiber bundles. The nanofibers within the same roped fiber bundle are entangled together. The roped fiber bundles are randomly oriented within the nanofiber nonwoven and are entangled with other roped fiber bundles within the nanofiber nonwoven. At least a portion of the nanofibers are entangled with and adhered to other nanofibers within the same roped fiber bundle and at least a portion of the roped fiber bundles are entangled with and adhered to other roped fiber bundles within the consolidated nanofiber nonwoven.

### BRIEF DESCRIPTION OF THE FIGURES

An embodiment of the present invention will now be described by way of example, with reference to the accompanying drawings.

FIG. 1 illustrates one embodiment of the nanofiber nonwoven.

FIGS. 2 and 3 are images of the production of roped fiber bundles containing nanofibers.

FIG. 4 illustrates one embodiment of the nanofiber nonwoven composite.

FIG. 5 illustrates one embodiment of the consolidated nanofiber nonwoven.

FIG. 6 is an SEM image of one embodiment of the nanofiber nonwoven at 300×.

FIG. 7 is an SEM image of one embodiment of the consolidated nanofiber nonwoven at 5,000×.

### DETAILED DESCRIPTION

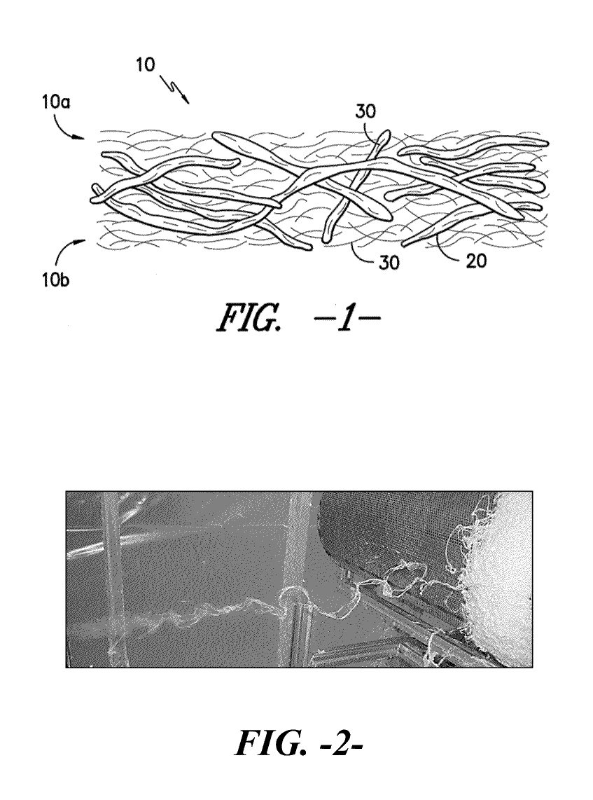

Referring now to FIG. 1, there is shown one embodiment of the nanofiber nonwoven 10 having a first side 10a and a second side 10b. The nanofiber nonwoven 10 contains a plurality of nanofibers 30. A portion of the nanofibers 30 are in roped fiber bundles 20. These roped fiber bundles have a length and a length axis and a majority of the nanofibers within the roped fiber bundles 20 are aligned with the length axis. The nanofibers 30 outside of the roped fiber bundles 20 preferably are randomly oriented in three dimensions and the roped fiber bundles are preferably randomly oriented in three dimensions.

A nanofiber nonwoven having roped fiber bundles creates a nonwoven with increased loft and increased porosity. This loft increases without introducing bulking, larger diameter fibers which could decrease other web properties. After the nanofibers are formed and leave the die, air is used to cool the nanofibers. Turbulence in the air stream causes entanglement and roping together to form larger bundles of fibers. The roped fiber bundles (also called entangled bundles) can then act as a larger, single fiber in forming a lofted nonwoven, increasing the overall porosity of the web. The tendency to form ropes increases with the fineness of the filaments; this effect is very pronounced for fibers less than 1 micron. The distance between the die producing nanofibers and the collector also has a high influence on rope formation. The roped fiber bundles tend to behave as a single macroscopic fiber of diameter equal to that of the rope bundle.

The nanofiber nonwoven 10 preferably has a high loft, meaning that it has a relatively low density. In one embodiment, the density of the nanofiber nonwoven 10 is preferably less than about 0.2 g/cm³, more preferably less than about 0.1 g/cm³, more preferably less than about 0.05 g/cm³.

The nanofibers 30 preferably have a median diameter of less than about 1000 nm, more preferably less than about 800 nm, more preferably less than about 500 nm, more preferably less than about 300 nm, more preferably less than about 100 nm, more preferably less than about 70 nm. It has been found that using smaller diameter fibers (moving from >1 μm to <1 μm) increases the amount of surface area compared to the volume of the fiber allowing for novel applications and properties. The nanofibers 30 may be continuous fibers or staple. The fibers may have any suitable cross-section including but not limited to circular, elliptical, regular or irregular, tape, rectangular, and multi-lobal.

The nanofibers 30 are characterized by very high surface area due to the small diameters of the individual fibers. The small fibers provide a high quantity of small pores and high amount of surface area for sorption of chemicals, filtration, and acoustic properties. In the case of filtering oil or liquid hydrocarbons form an aqueous medium, the nanofibers 30 are very efficient at absorbing and trapping the hydrocarbons. The high surface area provides a large quantity of absorption sites and the small pore sizes help trap the liquid into very small volumes. This forms a gel-like substance when the nanofiber nonwoven 10 has been saturated, which does not occur in larger fiber webs. Therefore, the retention capacity of a nanofiber nonwoven 10 has been found to be higher than in a larger fiber mat (i.e. the liquid absorbed does not drain back out as it would in a larger fiber/larger pore structure).

The nanofibers 30 are made up of any suitable material, preferably a thermoplastic polymer. A partial listing of polymers for use as the thermoplastic nanofiber include, but are not limited to, polyesters (e.g., polyethylene terephthalate (PET), glycol-modified PET (PETG), or polybutylene terephthalate (PBT)), polyamides (e.g., nylon 6 or nylon 6,6), polyethylenes (e.g., high density polyethylene (HDPE) or linear low density polyethylene (LLDPE)), polypropylenes, polystyrene, polyethylene oxide (PEO), polylactic acid, poly(1,4-cyclohexanedimethylene terephthalate) (PCT), polytetrafluoroethylene (PTFE) and combinations thereof. Nanofibers also include, but are not limited to, bicomponent binder fibers (e.g., bicomponent binder fibers comprising a thermoplastic sheath) and thermoplastic binder fibers having a relatively low melt flow rate. The nanofibers 30 may also have additives and/or coatings that enhance the performance of the nanofiber, such as nucleating agents, blooming additives to modify surface properties, UV stabilizers, antioxidants, antibacterial agents, additives that change the hydrophobicity or hydrophilicity of the fibers, charge enhancing additives, colors, etc. In one embodiment, the nanofibers comprise a thermoplastic polymer selected from the group consisting of polyester (PET), nylon, polyphenylene sulfide (PPS), polyethylene (PE), and co-polymers thereof.

The nanofibers 30 and the roped fiber bundles 20 of the nanofiber nonwoven 10 may be made in any manner able to produce thermoplastic nanofibers. One method to produce suitable nanofibers is melt-film fibrillation. Melt-film fibrillation is a high throughput process that extrudes a film or film tube which is fibrillated into small fibers via a high velocity gas. Near the exit of the slot or nozzle, high velocity gas shears the film against the tube or slot wall and fibrillates the polymer. By tuning the polymer flow, gas velocities, and nozzle geometry, the process can be used to create uniform fibers with diameters down to less than 500 nanometers in diameter, or even less than about 300 nm. The amount of nanofibers 30 forming within roped fiber bundles 20 is related to the distance between the die and the take-up mechanism. If the take up mechanism (i.e. a belt) is very close to the die, fewer nanofibers 30 would be formed into roped fiber bundles 20. When the take-up is further from the die (the distance for example being at least one half of the die width, or at least the die width) a greater percentage of the nanofibers 30 are formed into roped fiber bundles 20.

Two technologies using fibrillation have been developed which both utilize a round coaxial nozzle concept. The first is nanofibers by gas jet disclosed in several patents (U.S. Pat. No. 6,382,526, U.S. Pat. No. 6,520,425, and U.S. Pat. No. 6,695,992 all of which are incorporated by reference). The first technology uses a coaxial design, which also can include multiple coaxial tubes to add a surrounding “lip-cleaning” air, as well as multiple film tubes and multiple air streams.

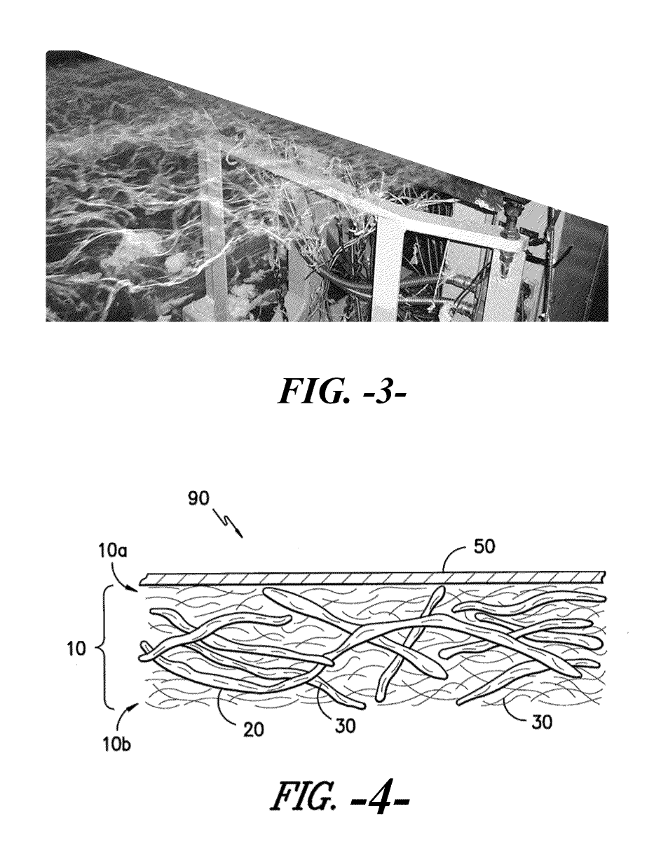

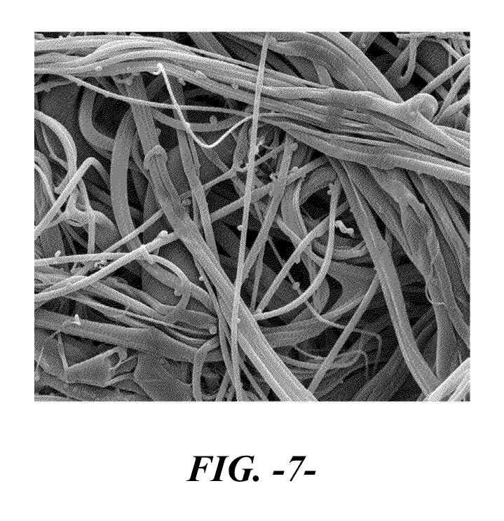

The second technology utilizes an array of nozzles using a melt-film fibrillation process, disclosed in several patents (U.S. Pat. No. 6,183,670 and U.S. Pat. No. 6,315,806 all of which are incorporated by reference). This technology uses round coaxial nozzles with a central air stream and an outer film tube. Molten polymer is fed into an array of these round nozzles with polymer melt and causing some nozzles to produce fine fiber (below 1 micron in diameter) and some to produce larger fiber (greater than 1 micron in diameter). Images of roped fiber bundles containing nanofibers produced by this process are shown in FIGS. 2 and 3. In this technology, a lower volume of air (higher velocity) is used to fiberize a given weight of resin in this process as compared to meltblowing. Additionally, the nature and degree of roping in a nonwoven web containing nanofibers formed from a die comprising an array of holes can be different than nanofibers formed from a continuous slot die. FIG. 6 is an SEM image of one embodiment of the nanofiber nonwoven at 300×.

Additionally, there is a variation on the technologies that use a film or slot form (U.S. Pat. No. 6,695,992). Conceptually, the process is an opened or “infinite” version of the film tube. The molten polymer is fed through one or more slots and has fibrillating gas streams and “lip-cleaning” streams essentially parallel to the film slot. A film sheet can then be extruded through a slot with a gas stream shearing the film against the lip and fibrillating the sheet into fine fibers.

Several other processes exist for making thermoplastic fibers with diameters below 1 micron. These processes include several of interest for this invention, including “electro-spinning”, “electro-blowing”, “melt-blowing”, “melt-film fibrillation”, “nanofiber by gas jet”, “melt fiber bursting”, “spinning melt” and “bicomponent” fibers (e.g. islands-in-sea, segmented pie). While these processes all produce fibers with submicron diameters, various fiber parameters may be unique to a particular process, such as processable materials, maximum throughput, average diameter and distribution, and fiber length. The nanofibers produced may be further processed into yarns, ropes, tapes, knits, woven or nonwoven textile constructions.

When the thermoplastic nanofibers (e.g. PP, PET, PBT) are formed, the nanofibers are carried in an air stream where they are free to entangle or “rope” together in the air stream carrying them in the formation process. The nanofibers can be collected on a drum, dual-drum, or belt systems to assemble into a nonwoven or blanket. The processing air, entraining air, mixing and roping of the fibers, die to collection distance, and collection method can be optimized to create a lofted, high porosity nanofiber web. After the nanofibers leave the die, air is used to cool the nanofibers. Turbulence in the air stream causes entanglement and roping together to form larger bundles of fibers. In addition, increasing the cooling rate can decrease the cohesion of the fibers as they entangle, thereby increasing loft. The roped fiber bundles (also called entangled bundles) can then act as a larger, single fiber in forming a lofted nonwoven, increasing the overall porosity of the web. It has been found that increasing the collection distance can allow more entrained air as well as more entanglement of the fibers. The drum or belt collection can further facilitate loft by balancing the dissipation of process and entrained air, such as with vacuum, with the collection of the nanofiber nonwoven into a lofted structure. A dual drum or belt setup can further facilitate achieving loft of the web. A fixed gap between the drums and removal of processing air more towards the normal to the fiber trajectory both increase the loft of the formed nonwoven.

Referring back to FIG. 1, the nanofibers 30 that are loose in the nanofiber nonwoven 10 (not in the roped fiber bundles 20) are preferably randomly oriented within the nanofiber nonwoven 10. In another embodiment, the nanofibers 30 not in the roped fiber bundles 20 are generally oriented in the z direction of the nanofiber nonwoven 10. The z direction is defined to be perpendicular to the first side 10a of the nanofiber nonwoven 10. In one embodiment, at least 30% by number of the nanofibers 30 not in roped fiber bundles 20 are oriented within 45 degrees of the z direction.

The roped fiber bundles 20 are macroscopic fiber bundles having a diameter from about 5 microns to 10 millimeters and containing a plurality of nanofibers 30. The roped fiber bundles 20 have a defined length and a defined length axis which runs along the length of the roped fiber bundles 20 as the centerline of the bundle. The length of the roped fiber bundles is preferably greater than 1 inch (2.54 cm), more preferably greater than 12 inches (30.5 cm). The roped fiber bundles are preferably randomly oriented within the nanofiber nonwoven 10 and are preferably entangled with other roped fiber bundles 20. When the nanofiber nonwoven 10 is pulled apart, the entangled roped fiber bundles 20 form a cobweb effect. The nanofibers 30 within the roped fiber bundles 20 are preferably generally aligned with the length axis of the roped fiber bundle 20. Preferably, at least 50% of the nanofibers by number are oriented within 45 degrees of the length axis along the entire length of the roped fiber bundles 20. The nanofibers 30 within the roped fiber bundles 20 are preferably entangled with other nanofibers 30 within the same roped fiber bundle 20. These nanofibers (within the same roped bundle) can also be mechanically entangled; some of the nanofibers can be adhered to each other along a length of 20 or more times their average diameter. This entangling of nanofibers 30 within the roped fiber bundles 20 and the entangling of the roped fiber bundles 20 with other roped fiber bundles 20 serves to provide some structural integrity to the nanofiber nonwoven 10. In addition, the nanofibers 30 not within a roped fiber bundle 20 are preferably entangled with roped fiber bundles 20 and other single nanofibers 30.

In one embodiment, the nanofiber nonwoven 10 is further mechanically stabilized. The bulk of the nanofiber nonwoven 10 has some intrinsic value due to its high surface area for use in certain applications such as filtration, thermal and acoustic insulation, and absorption applications. The loft (or density) of the nanofiber nonwoven 10 may be tailored to optimize specific performance attributes. If the resultant nanofiber nonwoven 10 needs greater tensile, shear, burst, and peel properties, one way to accomplish this is to mechanically stabilize the nanofiber nonwoven 10. This may be accomplished, for example by stitch stabilizing, point bonding, ultrasonic bonding or any other known method. These methods have been shown to increase the mechanically properties without significantly adversely affecting the loft and performance properties of the nanofiber nonwoven 10.

Through thickness stitching yarns allow attachment of machine, cross machine or off axis reinforcing yarns to provide strength to the nanofiber nonwoven 10, but also provide some through thickness shear strength to the nanofiber nonwoven 10 so that in use, a mechanical failure due to shear or peel can be mitigated. The choice of tricot or pillar (or other) stitch types, as well as the stitch frequency, allows the amount of compression of the nonwoven to be varied so the strength and available nanofiber surface area to be optimized. The stitching may be performed by a Malimo type stitching machine, a multiaxial knitting machine or other knit machine or z-pinning machine which uses a piercing needle to insert a pattern of reinforcing continuous yarns into/through the nanofiber web. Typical stitching yarns could be 70 denier, 150 denier or 300 denier continuous filament yarns (flat or textured), though other polymer types, yarn types and deniers could be used, depending on requirements.

In one embodiment, a blend of two or more size ranges of fibers may be used, for example nanofibers with a median diameter less than one micron and an micron-sized fibers having a median diameter greater than 1 micron, more preferably greater than 10 microns. The micron-sized fibers may be added to the nanofiber nonwoven 10 to provide the nonwoven at a lower cost point or to add additional bulk or other properties to the nanofiber nonwoven 10. The micron-sized fibers and nanofibers may be of the same polymer type or different and may have the same or different lengths. The nanofibers and micron-sized may be any suitable polymer type, for example the nanofibers may be polypropylene and the micron-sized fibers may be polypropylene, polyethylene, or polyester.

One example of micron-sized fibers is meltblown fibers. Meltblowing is a process of making fibrous webs, wherein high velocity air blows a molten thermoplastic polymer through a series of holes at the die tip onto a conveyor or take up screen to form a nonwoven web comprising 2-10 μm diameter fibers. In order to save cost, scrap waste generated during the meltblowing process is sent through a chopper gun to make short fibers that can then be used to fill booms for oil absorption.

Another example of micron-sized fibers is staple fibers which are traditionally used to make spun yarns or carded into nonwoven webs. The process used to make staple fibers consists of the following steps—Extrusion or spinning, drawing, crimping and packaging. Thermoplastic polymer staple fibers are usually between 15 and 40 μm in diameter and several inches long. In another embodiment, the micron-sized fibers are staple fibers in the form of “fiber clusters” or “fiber balls” as described in U.S. Pat. No. 6,613,431 which describes a modified carding machine that mechanically twists and entangles polyester fibers into fiber balls.

In one embodiment, the percentages of the fiber blend being nanofibers is between about 2 and 98% by weight, more preferably about 10 and 90%, more preferably about 20 and 80%, more preferably about 30 and 70%, more preferably about 20 and 60%, more preferably about 30 and 50% with the remainder being micron-sized fibers. In another embodiment, the nanofiber nonwoven comprises between about 22 and 95% by weight nanofibers (and between about 5 and 78% by weight micron-sided fibers). In one embodiment, the ratio by weight of the nanofiber to micron-sized fiber is between 20:80 and 80:20, more preferably between 30:70 and 65:35.

In one embodiment, the micron sized fibers have an anti-static coating(antistat) applied to the fibers, preferably in a range of between about 2 and 5% by weight of the micron fibers. The antistat serves to control the static electricity of the blend during blending and prevent clumping and melting of the blend.

An additional benefit of using staple fibers in the blend is that by using crimped and/or voluminous fibers the overall volume of the blend can be increased. These staple fibers allow for a pseudo web structure within the blend that offers a backbone of support to keep the nanofibers 30 and the roped fiber bundles 20 well distributed and the nanofiber surfaces well exposed. The addition of these staple fibers, especially those with crimp and/or other voluminous characteristics, allows for the blend to be packaged by traditional methods as well as allowing for the packaging with a quick recovery of the blend volume.

In another embodiment, the nanofiber nonwoven 10 contains binder fibers. These binder fibers may be a separate fiber or the nanofibers 30 may serve as binder fibers. The binder fibers are fibers that form an adhesion or bond with the other fibers. Binder fibers can include fibers that are heat activated. Examples of heat activated binder fibers are fibers that can melt at lower temperatures, such as low melt fibers, bi-component fibers, such as side-by-side or core and sheath fibers with a lower sheath melting temperature, and the like. In one embodiment, the binder fibers are a polyester core and sheath fiber with a lower melt temperature sheath. A benefit of using a heat activated binder fiber as the binder fiber in the nanofiber nonwoven layer 10, is that the layer can be subsequently molded to part shapes for use in automotive hood liners, engine compartment covers, ceiling tiles, office panels, etc. The binder fibers are preferably staple fibers.

Any other suitable fiber may also be used in the nanofiber nonwoven 10 in addition to the nanofibers 30. These may include, but are not limited to a second type of nanofiber fiber having a different denier, staple length, composition, or melting point, and a fire resistant or fire retardant fiber. The fiber may also be an effect fiber, providing benefit a desired aesthetic or function. These effect fibers may be used to impart color, chemical resistance (such as polyphenylene sulfide fibers and polytetrafluoroethylene fibers), moisture resistance (such as polytetrafluoroethylene fibers and topically treated polymer fibers), or others. In one embodiment, the nanofiber nonwoven 10 contains fire resistant fibers. As used herein, fire retardant fibers shall mean fibers having a Limiting Oxygen Index (LOI) value of 20.95 or greater, as determined by ISO 4589-1. Types of fire retardant fibers include, but are not limited to, fire suppressant fibers and combustion resistant fibers. Fire suppressant fibers are fibers that meet the LOI by consuming in a manner that tends to suppress the heat source. In one method of suppressing a fire, the fire suppressant fiber emits a gaseous product during consumption, such as a halogenated gas. Examples of fiber suppressant fibers include modacrylic, PVC, fibers with a halogenated topical treatment, and the like. Combustion resistant fibers are fibers that meet the LOI by resisting consumption when exposed to heat. Examples of combustion resistant fibers include silica impregnated rayon such as rayon sold under the mark VISIL®, partially oxidized polyacrylonitrile, polyaramid, para-aramid, carbon, meta-aramid, melamine and the like.

Any or all of the fibers in the nanofiber nonwoven 10 may additionally contain additives. Suitable additives include, but are not limited to, fillers, stabilizers, plasticizers, tackifiers, flow control agents, cure rate retarders, adhesion promoters (for example, silanes and titanates), adjuvants, impact modifiers, expandable microspheres, thermally conductive particles, electrically conductive particles, silica, glass, clay, talc, pigments, colorants, glass beads or bubbles, antioxidants, optical brighteners, antimicrobial agents, surfactants, fire retardants, and fluoropolymers. One or more of the above-described additives may be used to reduce the weight and/or cost of the resulting fiber and layer, adjust viscosity, or modify the thermal properties of the fiber or confer a range of physical properties derived from the physical property activity of the additive including electrical, optical, density-related, liquid barrier or adhesive tack related properties.

In one embodiment, wax or any other blooming agent that provides lubrication, may be added to the nanofibers as an additive. The wax tends to bloom to the surface of the nanofiber during extrusion. The wax, such as Paracin (Paricin®285 (available from Vertellus), N,N′-Ethylene bis-12-hydroxystearamide, is a brittle wax-like solid formed from the reaction of an amine with hydroxystearic acid), or polymer blends reduce the cohesion between the individual fibers or otherwise facilitate increased loft. It has been observed that the addition of wax further enhances the entanglement of the nanofibers into larger roped bundles, thereby increasing the overall loft of the nonwoven. The decreased adhesion allows the fibers to more thoroughly entangle mechanically through the air stream. The wax tends to bloom to the surface of the nanofiber during fiber formation, reducing fiber-fiber bonding and web compaction during collection. A higher percentage of fibers were part of larger rope bundles when a wax additive was used.

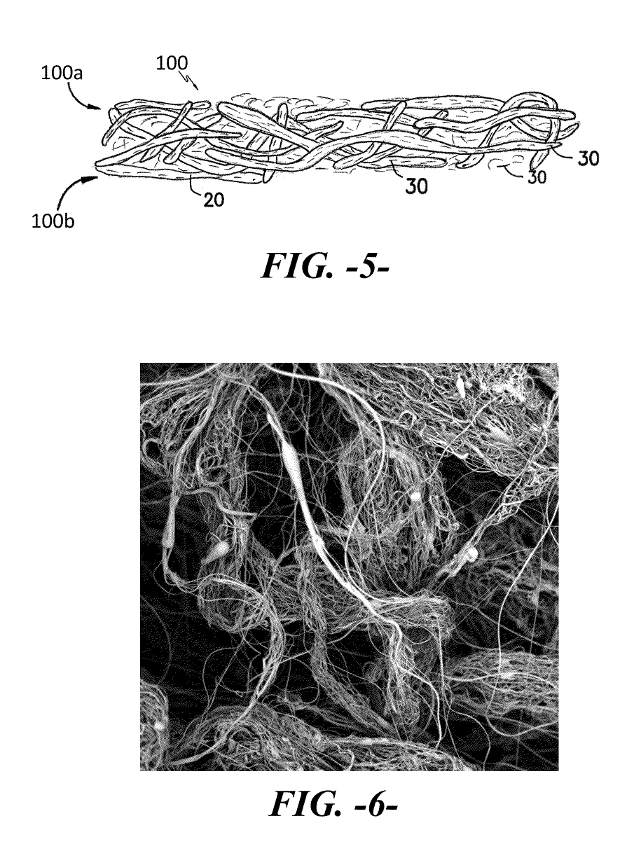

In some embodiments, the nanofiber nonwoven 10 further contains an additional layer on at least one side forming a nanofiber nonwoven composite 90 as shown in FIG. 4. The additional layer may be any suitable layer for the nanofiber nonwoven composite 90. In one embodiment, the additional layer 50 is located adjacent to the first side 10a of the nanofiber nonwoven 10. In another embodiment, a second additional layer may be located adjacent the second side 10b of the nanofiber nonwoven 10. In further embodiments, more additional layers may be stacked on one or both sides of the nanofiber nonwoven 10.

The additional layer may be, but is not limited to, a woven textile, a knit textile, a nonwoven textile, and a film. In the embodiments where the additional layer 50 is a textile, the textile may be of any suitable construction and composition. The textile is preferably made out of a yarn or material that is selected to give the desired tensile, abrasion, and ductile characteristics. For a small article, the tensile strength may not be as important as when the article is a tube that may be several thousand feet long and will be wound and unwound. In one embodiment, the textile is an open construction to allow for the passing of air/gases/liquids or other materials through the textile to reach the nanofiber nonwoven 10. The materials forming the additional layer 50 may be any of the polymers listed for use as possible nanofibers as well as any other thermoplastic or thermoset, natural or synthetic material.

Some suitable materials for the yarns/fibers in the additional layer 50 being a textile include polyamide, aramid (including meta and para forms), rayon, PVA (polyvinyl alcohol), polyester, polyolefin, polyvinyl, nylon (including nylon 6, nylon 6,6, and nylon 4,6), polyethylene naphthalate (PEN), cotton, steel, carbon, fiberglass, steel, polyacrylic, polytrimethylene terephthalate (PTT), polycyclohexane dimethylene terephthalate (PCT), polybutylene terephthalate (PBT), PET modified with polyethylene glycol (PEG), polylactic acid (PLA), polytrimethylene terephthalate, nylons (including nylon 6 and nylon 6,6); regenerated cellulosics (such as rayon or Tencel); elastomeric materials such as spandex; high-performance fibers such as the polyaramids, and polyimides natural fibers such as cotton, linen, ramie, and hemp, proteinaceous materials such as silk, wool, and other animal hairs such as angora, alpaca, and vicuna, fiber reinforced polymers, thermosetting polymers, blends thereof, and mixtures thereof.

In one embodiment, the additional layer 50 being a textile may contain some or all high tenacity yarns or fibers. These high modulus fibers may be any suitable fiber having a modulus of at least about 4 GPa, more preferably greater than at least 15 GPa, more preferably greater than at least 70 GPa. Some examples of suitable fibers include glass fibers, aramid fibers, and highly oriented polypropylene fibers as described in U.S. Pat. No. 7,300,691 by Eleazer et al. (herein incorporated by reference), bast fibers, and carbon fibers. A non-inclusive listing of suitable fibers for the high modulus fibers 110 of the first layer 100 include, fibers made from highly oriented polymers, such as gel-spun ultrahigh molecular weight polyethylene fibers (e.g., SPECTRA® fibers from Honeywell Advanced Fibers of Morristown, N.J. and DYNEEMA® fibers from DSM High Performance Fibers Co. of the Netherlands), melt-spun polyethylene fibers (e.g., CERTRAN® fibers from Celanese Fibers of Charlotte, N.C.), melt-spun nylon fibers (e.g., high tenacity type nylon 6,6 fibers from Invista of Wichita, Kans.), melt-spun polyester fibers (e.g., high tenacity type polyethylene terephthalate fibers from Invista of Wichita, Kans.), and sintered polyethylene fibers (e.g., TENSYLON® fibers from ITS of Charlotte, N.C.). Suitable fibers also include those made from rigid-rod polymers, such as lyotropic rigid-rod polymers, heterocyclic rigid-rod polymers, and thermotropic liquid-crystalline polymers. Suitable fibers made from lyotropic rigid-rod polymers include aramid fibers, such as poly(p-phenyleneterephthalamide) fibers (e.g., KEVLAR® fibers from DuPont of Wilmington, Del. and TWARON® fibers from Teijin of Japan) and fibers made from a 1:1 copolyterephthalamide of 3,4′-diaminodiphenylether and p-phenylenediamine (e.g., TECHNORA® fibers from Teijin of Japan). Suitable fibers made from heterocyclic rigid-rod polymers, such as p-phenylene heterocyclics, include poly(p-phenylene-2,6-benzobisoxazole) fibers (PBO fibers) (e.g., ZYLON® fibers from Toyobo of Japan), poly(p-phenylene-2,6-benzobisthiazole) fibers (PBZT fibers), and poly[2,6-diimidazo[4,5-b:4′,5′-e]pyridinylene-1,4-(2,5-dihydroxy)phenylene] fibers (PIPD fibers) (e.g., M5® fibers from DuPont of Wilmington, Del.). Suitable fibers made from thermotropic liquid-crystalline polymers include poly(6-hydroxy-2-napthoic acid-co-4-hydroxybenzoic acid) fibers (e.g., VECTRAN® fibers from Celanese of Charlotte, N.C.). Suitable fibers also include boron fibers, silicon carbide fibers, alumina fibers, glass fibers, carbon fibers, such as those made from the high temperature pyrolysis of rayon, polyacrylonitrile (e.g., OFF® fibers from Dow of Midland, Mich.), and mesomorphic hydrocarbon tar (e.g., THORNEL® fibers from Cytec of Greenville, S.C.). In another embodiment, the additional layer 50 being a textile contains yarns and/or fibers containing thermoplastic polymer, cellulose, glass, ceramic, and mixtures thereof.

In one embodiment, the additional layer 50 is a woven textile. The woven textile may also be, for example, plain, satin, twill, basket-weave, poplin, jacquard, and crepe weave textiles. Preferably, the woven textile is a plain weave textile. It has been shown that a plain weave textile has good abrasion and wear characteristics. A twill weave has been shown to have good properties for compound curves so may also be preferred for some textiles. The end count in the warp direction is between 35 and 70 in one embodiment. The denier of the warp yarns is between 350 and 1200 denier in one embodiment. In one embodiment, the woven textile is air permeable.

In another embodiment, the additional layer 50 is a knit textile, for example a circular knit, reverse plaited circular knit, double knit, single jersey knit, two-end fleece knit, three-end fleece knit, terry knit or double loop knit, weft inserted warp knit, warp knit, and warp knit with or without a micro-denier face.

In another embodiment, the additional layer 50 is a multi-axial, such as a tri-axial textile (knit, woven, or nonwoven). In another embodiment, the additional layer 50 is a bias textile. In another embodiment, the additional layer 50 is a scrim.

In another embodiment, the additional layer 50 is a nonwoven textile. The term “nonwoven textile” refers to structures incorporating a mass of yarns that are entangled and/or heat fused so as to provide a coordinated structure with a degree of internal coherency. Nonwoven textiles for use as the textile may be formed from many processes such as for example, meltspun processes, hydroentangling processes, meltblown processes, spunbond processes, composites of the same mechanically entangled processes, stitch-bonded and the like. In another embodiment, the textile is a unidirectional textile and may have overlapping yarns or may have gaps between the yarns.

In another embodiment, the additional layer 50 is a film, preferably a thermoplastic film. In one embodiment, the thermoplastic film is air impermeable. In another embodiment, the thermoplastic film has some air permeability due to apertures including perforations, slits, or other types of holes in the film. The thermoplastic film can have any suitable thickness, density, or stiffness. Preferably, the thickness of the film is between less than 2 and 50 microns thick, more preferably the film has a thickness of between about 5 and 25 microns, more preferably between about 5 and 15 microns thick. In one embodiment, the thermoplastic film may contain any suitable additives or coatings, such as an adhesion promoting coating. If the end use of the nanofiber nonwoven composite 90 is an acoustic use, the film thickness and mechanical properties are chosen to absorb acoustic energy, while minimizing reflections of acoustic energy.

In one embodiment, the materials of the additional layer 50, the nanofibers 30 in the nanofiber nonwoven 10 and any other fibers in the nanofiber nonwoven 10 are selected such that they are all the same class, for example each element is polyester or each element is polypropylene. This creates a nanofiber nonwoven composite 90 where all of the elements are comprised of the same polymeric material (e.g., polyester), so that the composite is more easily recyclable.

The additional layer 50 may be attached by any known means to the nanofiber nonwoven 10 or may simply have been laid on and not attached by any means. In one embodiment, the fibers in the nanofiber nonwoven 10 provide for some adhesion by binding the nanofiber nonwoven 10 and the additional layer 50 when melted and subsequently cooled. In another embodiment, an adhesive layer may be used between the additional layer 50 and the nanofiber nonwoven 10. The adhesive layer may be any suitable adhesive, including but not limited to a water-based adhesive, a solvent-based adhesive, and a heat or UV activated adhesive. The adhesive may be applied as a free standing film, a coating (continuous or discontinuous, random or patterned), a powder, or any other known means. In another embodiment, the additional layer 50 may be attached to the nanofiber nonwoven 10 by attachment devices such as mechanical fasteners like screws, nails, clips, staples, stitching, thread, hook and loop materials, etc. In the case of the consolidated nanofiber nonwoven composite, the additional layer may be applied at suitable time during manufacture, including before or after consolidation of the nanofiber nonwoven.

The nanofiber nonwoven 10 and the nanofiber nonwoven composite 90 may also contain any additional layers for physical or aesthetic purposes. Suitable additional layers include, but are not limited to, a nonwoven textile, a woven textile, a knitted textile, a foam layer, a film, a paper layer, an adhesive-backed layer, a foil, a mesh, an elastic textile (i.e., any of the above-described woven, knitted or nonwoven textiles having elastic properties), an apertured web, an adhesive-backed layer, an aesthetic surface, or any combination thereof. Other suitable additional layers include, but are not limited to, a color-containing layer (e.g., a print layer); one or more additional sub-micron fiber layers having a distinct average fiber diameter and/or physical composition; one or more secondary fine fiber layers for additional insulation performance (such as a melt-blown web or a fiberglass textile); foams; layers of particles; foil layers; films; decorative textile layers; membranes (i.e., films with controlled permeability, such as dialysis membranes, reverse osmosis membranes, etc.); netting; mesh; wiring and tubing networks (i.e., layers of wires for conveying electricity or groups of tubes/pipes for conveying various fluids, such as wiring networks for heating blankets, and tubing networks for coolant flow through cooling blankets); or a combination thereof.

In one embodiment, the nanofiber nonwoven 10 and/or the nanofiber nonwoven composite 90 may be further consolidated before their end use. Consolidation is the process of using heat and/or pressure to create internal binding points throughout the nanofiber nonwoven 10 and/or the nanofiber nonwoven composite 90. After consolidation, the resultant structure is typically thinner (distance between 10a and 10b, or 90a, and 90b) is reduced. At least a portion of the nanofibers 30 within a roped fiber bundle 20 are adhered (typically through partially melting and cooling) to other nanofibers 30 within the roped fiber bundle 20. At least a portion of the roped fiber bundles 20 are adhered to other roped fiber bundles 20. At least a portion of the nanofibers 30 that are not in roped fiber bundles 20 are adhered to other “loose” nanofibers 30 or to roped fiber bundles 20.

FIG. 5 illustrates a consolidated nanofiber nonwoven 100 having a first side 100a and a second side 100b and containing nanofibers 30 both loose throughout the consolidated nanofiber nonwoven and in roped fiber bundles 20. Additional layers can be added at any stage of the process including as the nanofiber nonwoven is formed, after the nanofiber nonwoven is formed but before consolidation, or after consolidation. FIG. 7 is an SEM image of one embodiment of the consolidated nanofiber nonwoven at 5,000×.

Consolidating the nanofiber web allows for controlling the porosity and pore sizes to a set amount. This can be advantageous for applications in air and liquid filtration, acoustic barriers, and membrane applications, including battery separators. Some membrane applications include, but are not limited to, include house wraps, breathable membranes, water impermeable membranes, and vapor permeable membranes. In the housewrap application, the nanofiber layer will be usually consolidated and bonded to a strengthening scrim like a weft inserted warp knit scrim.

The porosity and the average pore size of the nanofiber nonwoven web can be tuned by consolidating them at different pressures. At the same basis weight, consolidated nanofiber nonwovens have a higher number of small pores when compared to a consolidated sample containing larger fibers. Also of note, under consolidation pressure nanofibers can begin to fuse together even at room temperature. Nanofiber webs containing roped bundles of nanofibers may not consolidate or fuse together in the same manner under similar consolidation pressure.

The nanofiber nonwoven 10 and the nanofiber nonwoven composite 90 may further comprise one or more attachment devices to enable attachment to a substrate or other surface. In addition to adhesives, other attachment devices may be used such as mechanical fasteners like screws, nails, clips, staples, stitching, thread, hook and loop materials, etc.

The one or more attachment devices may be used to attach the nanofiber nonwoven 10 and the nanofiber nonwoven composite 90 to a variety of substrates. Exemplary substrates include, but are not limited to, a vehicle component; an interior of a vehicle (i.e., the passenger compartment, the motor compartment, the trunk, etc.); a wall of a building (i.e., interior wall surface or exterior wall surface); a ceiling of a building (i.e., interior ceiling surface or exterior ceiling surface); a building material for forming a wall or ceiling of a building (e.g., a ceiling tile, wood component, gypsum board, etc.); a room partition; a metal sheet; a glass substrate; a door; a window; a machinery component; an appliance component (i.e., interior appliance surface or exterior appliance surface); filter component; a surface of a pipe or hose; a computer or electronic component; a sound recording or reproduction device; a housing or case for an appliance, computer, etc. Attaching the nanofiber nonwoven 10 and the nanofiber nonwoven composite 90 may provide acoustic absorption.

The nanofiber nonwoven, nanofiber nonwoven composite, consolidated nanofiber nonwoven, and the consolidated nanofiber nonwoven composite can be used for any suitable purpose. Some example of what the nanofiber nonwoven, nanofiber nonwoven composite, consolidated nanofiber nonwoven, and the consolidated nanofiber nonwoven composite may be used for include absorbing sound, for filtering airborne or liquid contaminants, for separating electrodes in a battery and holding electrolyte, and for forming a vapor permeable, water impermeable structure. The nanofiber nonwoven, nanofiber nonwoven composite, consolidated nanofiber nonwoven, and the consolidated nanofiber nonwoven composite may used by itself, with other components, or attached to other structures. The nanofiber nonwoven, nanofiber nonwoven composite, consolidated nanofiber nonwoven, and the consolidated nanofiber nonwoven composite may be used in any suitable end use, for example, as an acoustic media, a filter media, a sorbent media, a battery separator, and a membrane.

### EXAMPLES

### Example 1

Example was a competitive melt-blown nonwoven having micron-sized fibers. A meltblow sample from Johns Manville, product AutoZorb II 2 CF was obtained with a nominal weight of 25 g/ft² (269 g/m²) and 10 mm thickness. Removal of the scrims on both sides gave a measured weight of 205 g/m² and thickness 8 mm for the lofty meltblown core layer of polypropylene fiber.

### Example 2

Example 2 was a nanofiber nonwoven produced using the method described in U.S. Pat. Nos. 6,183,670 and 6,315,806 with a 2 inch wide die. The thermoplastic polymer used was polypropylene available from Exxon as 6936G1 PP resin. The nanofiber nonwoven was collected in a rotating/traversing drum. The resultant nanofiber nonwoven contained roped fiber bundles. The fiber size was measured from images of the nanofibers using SEM. The fiber diameters were measured from 135 counts of nanofibers and determined to be in the range of 110 nm to 1350 nm with a median value of 520 nm.

### Example 3

Example 3 was formed as described in Example 2, except that in addition to the polypropylene used, 0.5% wt of Paracin wax (Paricin®285 obtained from Vertellus Inc.) Paricin®285 (available from Vertellus), N,N′-Ethylene bis-12-hydroxystearamide, is a brittle wax-like solid formed from the reaction of an amine with hydroxystearic acid. The resultant nanofiber nonwoven contained roped fiber bundles.

### Example 4

Example 4 was formed as described in Example 2, except that in addition to the polypropylene used, 2% wt of Paracin wax (Paricin®285) was added to the polymer to be extruded. The resultant nanofiber nonwoven contained roped fiber bundles.

| | | | | Density | Porosity |
|---|---|---|---|---|---|
| Example | 12″ weight (g) | Thickness (in) | g/m² | (g/cm³) | (%) |
| 1 | 19.0 | 0.32 | 205 | 0.0228 | 97.2 |
| 2 | 27.3 | 0.88 | 294 | 0.0132 | 98.5 |
| 3 | 21.3 | 1.16 | 229 | 0.0078 | 99.1 |
| 4 | 21.7 | 1.09 | 233 | 0.0074 | 99.1 |

As one can see from the results table above, using nanofiber nonwovens having roped fiber bundles showed lower weights, higher thicknesses, lower density, and higher porosity than the micron-sized nonwoven. In addition, the addition of wax into the polymer also made a loftier, lower density and higher porosity product.

### Example 5

Example 5 was a nanofiber nonwoven produced using the method described in U.S. Pat. Nos. 6,183,670 and 6,315,806 with a 1 meter wide die. The thermoplastic polymer used was 1800 MFI polypropylene resin available from Lyondell Basell as MF650 Y. The nanofiber nonwoven was collected on a moving belt with vacuum suction. The resultant nanofiber nonwoven had a nominal basis weight of 100 g/m² and contained roped fiber bundles. The fiber size was measured from images of the nanofibers using SEM. The fiber diameters were measured from 278 counts of nanofibers and determined to be in the range of 150 nm to 4580 nm with a median value of 665 nm. The nanofiber nonwoven was then consolidated under a pressure of 600 psi using a room temperature calendar (steel rollers on top and nylon rollers on the bottom). The consolidated nonwoven had a thickness of 227 microns and a bubble point measured using a PMI capillary porometer of 1.97 psi.

### Example 6

Example 6 was a nanofiber nonwoven produced using the method described in US Patents 6,183,670 and 6,315,806 with a 1 meter wide die. The thermoplastic polymer used was a 1800 MFI polypropylene resin available from Lyondell Basell as MF650 Y. The nanofiber nonwoven was collected on a moving belt with vacuum suction. The resultant nanofiber nonwoven had a nominal basis weight of 100 g/m² and contained roped fiber bundles. The fiber size was measured from images of the nanofibers using SEM. The fiber diameters were measured from 278 counts of nanofibers and determined to be in the range of 150 nm to 4580 nm with a median value of 665 nm. The nanofiber nonwoven was then consolidated under a pressure of 600 psi using a room temperature calendar (steel rollers on top and nylon rollers on the bottom). The consolidated nonwoven had a thickness of 219 microns and a bubble point measured using a PMI capillary porometer of 2.57 psi.

As can be seen from Examples 5 and 6, nanofiber nonwovens with different average pore size (bubble points) can be produced by consolidating them at different calendar pressures. The consolidated nanofiber nonwovens with small average pore sizes have broad applications in removing micron and sub-micron sized contaminants from liquids.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A consolidated nanofiber nonwoven having a first side and a second side comprising a plurality of roped fiber bundles having a length axis, wherein the roped fiber bundles comprise a plurality of nanofibers having a median diameter of less than one micrometer, wherein at least 50% by number of the nanofibers are oriented within 45 degrees of the length axis of the roped fiber bundles, wherein the roped fiber bundles are randomly oriented within the nanofiber nonwoven,
wherein at least a portion of the nanofibers are entangled with and adhered to other nanofibers within the same roped fiber bundle, and
wherein at least a portion of the roped fiber bundles are entangled with and adhered to other roped fiber bundles within the consolidated nanofiber nonwoven.

2. The consolidated nanofiber nonwoven of claim 1, further comprising an additional layer selected from the group consisting of a woven textile, a knit textile, a nonwoven textile, and a film on at least the first side of the nanofiber nonwoven.

3. The consolidated nanofiber nonwoven of claim 2, further comprising an adhesive layer between the consolidated nanofiber nonwoven and the additional layer.

4. The consolidated nanofiber nonwoven of claim 1, wherein the nanofiber nonwoven is mechanically stabilized.

5. The consolidated nanofiber nonwoven of claim 1, wherein the length of the roped fiber bundles is greater than 12 inches.

6. The consolidated nanofiber nonwoven of claim 1, wherein the nanofiber nonwoven is attached to a substrate, the substrate selected from the group consisting of a wall of a building, a ceiling of a building, a building material for forming a wall or ceiling of a building, a metal sheet, a glass substrate, a door, a window, a vehicle component, a machinery component, filter component, and an appliance component.

7. The consolidated nanofiber nonwoven of claim 1, wherein the nanofibers comprise a thermoplastic polymer.

8. A consolidated nanofiber nonwoven composite comprising a nanofiber nonwoven having a first side and a second side and a layer selected from the group consisting of a woven textile, a knit textile, a nonwoven textile, and a film on at least the first side of the nanofiber nonwoven, wherein the nanofiber nonwoven comprises a plurality of roped fiber bundles having a length axis, wherein the roped fiber bundles comprise a plurality of nanofibers having a median diameter of less than one micrometer, wherein at least 50% by number of the nanofibers are oriented within 45 degrees of the length axis of the roped fiber bundles, wherein the roped fiber bundles are randomly oriented within the nanofiber nonwoven,
wherein at least a portion of the nanofibers are entangled with and adhered to other nanofibers within the same roped fiber bundle, and
wherein at least a portion of the roped fiber bundles are entangled with and adhered to other roped fiber bundles within the consolidated nanofiber nonwoven.

9. The consolidated nanofiber nonwoven composite of claim 8, further comprising an adhesive layer between the consolidated nanofiber nonwoven and the additional layer.

10. The consolidated nanofiber nonwoven composite of claim 8, wherein the nanofiber nonwoven is mechanically stabilized.

11. The consolidated nanofiber nonwoven composite of claim 8, wherein the length of the roped fiber bundles is greater than 12 inches.

12. The consolidated nanofiber nonwoven composite of claim 8, wherein the nanofiber nonwoven is attached to a substrate, the substrate selected from the group consisting of a wall of a building, a ceiling of a building, a building material for forming a wall or ceiling of a building, a metal sheet, a glass substrate, a door, a window, a vehicle component, a machinery component, and an appliance component.

13. The consolidated nanofiber nonwoven composite of claim 8, wherein the nanofibers comprise a thermoplastic polymer.

14. A method of filtering liquids or gases, said method comprising the steps of passing a liquid or a gas though a consolidated nanofiber nonwoven having a first side and a second side comprising a plurality of roped fiber bundles having a length axis, wherein the roped fiber bundles comprise a plurality of nanofibers having a median diameter of less than one micrometer, wherein at least 50% by number of the nanofibers are oriented within 45 degrees of the length axis of the roped fiber bundles, wherein the roped fiber bundles are randomly oriented within the nanofiber nonwoven,
wherein at least a portion of the nanofibers are entangled with and adhered to other nanofibers within the same roped fiber bundle, and
wherein at least a portion of the roped fiber bundles are entangled with and adhered to other roped fiber bundles within the consolidated nanofiber nonwoven.

15. The method of claim 14, further comprising an additional layer selected from the group consisting of a woven textile, a knit textile, a nonwoven textile, and a film on at least the first side of the nanofiber nonwoven.

16. The method of claim 15, further comprising an adhesive layer between the consolidated nanofiber nonwoven and the additional layer.

17. The method of claim 14, wherein the nanofiber nonwoven is mechanically stabilized.

18. The method of claim 14, wherein the length of the roped fiber bundles is greater than 12 inches.

19. The method of claim 14, wherein the nanofiber comprise a thermoplastic polymer.

20. The method of claim 14, wherein the nanofibers comprise a thermoplastic polymer selected from the group consisting of polyester, nylon, polypropylene, polyphenylene sulfide, poly butylene terephthalate, polyethylene, and co-polymers thereof.
